(19) United States
(12) Patent Application Publication
(10) Pub. No.: US 2012/0125965 A1
(43) Pub. Date: May 24, 2012

(54) Ergonomic Hitch Bicycle Rack

(76) Inventor: Roberto Martin Castro, Monterrey (MX)

(21) Appl. No.: 12/952,881

(22) Filed: Nov. 23, 2010

(51) Int. Cl. B60R 9/06; B60R 9/00

(52) U.S. Cl. 224/534; 224/533

(57) ABSTRACT

A bicycle rack configured for mounting to a hitch behind a vehicle. The rack has a carrier frame which includes mounting devices for supporting and securing up to four bicycles. The rack has a central upright frame named mast, with a lower end structure named hitch, for detachably securing the bicycle rack to a conventional hitch receiver, which is attached to the motor vehicle with a bolt, adjustable for effecting relative displacement of the two members transversely to the hitch making a tight friction-fit of the coupling to keep the bicycle rack from vibrating in the hitch receiver. The anti-sway bar rotates on a transverse axis from an horizontal locked position adjacent to the mast, co-acting with the mounting devices of the carrier to secure and stabilize each bicycle at a third point on the rack. The bike rack includes a mechanism for locking the mast & carrier in an upright position, or alternatively permitting downward rotation of the mast & carrier in various angles for access purposes of the vehicle's rear compartment.

### DESCRIPTION OF THE PREFERRED EMBODIMENT

The rack here described is also shown in FIG. 1 through FIG. 8. The Carrier #3 goes mounted on the mast #2 and the mast #2 goes on the hitch #1 and the hitch #1 is mounted on the hitch receiver of the Vehicle.

When assembled, the rack is a four piece structure. For descriptive purposes we shall name these four main pieces; the carrier #3 the mast #2 the hitch #1 and the stabilizer #4.

The hitch #1 is the piece that joins the rack to the vehicle by securing it to the hitch receiver with a ¾″ bolt #11, washer #23 and nut #17. The hitch #1 can come in 2″ squared and 1¼″ squared in order to fit most common hitch receivers.

The mast #2 is the vertical frame that joins the Carrier #3 and the hitch #1. The mast #2 is attached to the hitch #1 by a ¾″ bolt #10, washer #20, nut #16 and has two spacers #21 ,#22. The spacers #21,#22 fit between the mast #2 and the hitch #1, both are ½″ in length.

By adjusting the mast/hitch pin #6 the mast #2 can assume 4 positions. When the mast/hitch pin #6 is inserted through mast holes #34 and hitch holes #38, the mast #2 assumes a fixed upright position at 90° in respect to the hitch #1.

When the mast/hitch pin #6 is inserted through the mast holes #32 without going through the hitch #1, the mast #2 can move downward 50° and away from the upright position of 90° and away from the vehicle. This enables the access to the rear compartment of the vehicle.

When the mast/hitch pin #6 is inserted through the mast holes #32 and the hitch holes #35, the mast assumes a fixed horizontal position 90° down and away from the upright position and the vehicle. This position is completely horizontal. This enables the access to the rear compartment of the vehicle without having to remove the rack.

The carrier #3 is the metal frame that holds the bicycles. The carrier #3 is attached to the mast #2 with a 6⅛″ bolt #8, washer #18, nut #14 and two spacers #12 and #13. The spacers have different lengths. Spacer #13 has a length of 1.25″ and fits between the carrier #3 and the mast #1 on the opposite side of the anti-sway bar #4, which is to say , the left side of the mast#2 from a front side view FIG. 5. The spacer #12 has a length of 2″ and fits between the carrier #3 and the mast #2 on the same side of the mast #2 that the anti-sway bar #4 is located, which is to say, the right side of the mast #2 from a front side view FIG. 5.

By adjusting the carrier/mast pin #5, the carrier #3 can assume 2 positions. When the carrier/mast pin #5 is inserted through the carrier holes #24 and the mast holes #27 the carrier #3 assumes a fixed closed position at 0° in respect to the mast #2, where the carrier #3 and the mast #2 are parallel to each other.

When the carrier/mast pin #5 is inserted through the carrier holes #26 and the mast holes #29, the carrier #3 rotates to a fixed extended position at 120° up and away from the mast #2 and away from the vehicle.

The carrier #3 has four indentations #40 where the bicycles are placed. Each indentation #4 can carry one bicycle when the carrier #3 is in the extended position.* *It is understood that the carrier can have less than 4 indentations #4. For example, three, two, or one indentation #4.

The straps #41 are used to hold and secure the bicycles to the carrier #3. The straps #41 go through the strap holes #42, around the bicycle frame and are hooked in the metal pegs #43.

The anti-sway bar #4 is attached to the mast #2 with a bolt #9, a washer #19 and a nut #15. The anti-sway bar #4 rotates on the bolt #9 from an upright position, parallel to the mast #2, to a perpendicular position in regards to the mast #2. When perpendicular to the mast #2, the anti-sway bar #4 aligns with the bicycle pedals and secures the pedals with the straps #41 in order to prevent the swaying of the bicycles.

### BACKGROUND OF THE INVENTION

1. Field of Invention

This invention relates to the field of carrier racks for transporting bicycles on a road vehicle, and more particularly pertains to improved trailer hitch mountings for such bicycle carrier racks.

2. State of the Prior Art

Many bicycle carrier racks are in use, some of which are adapted for mounting to an existing trailer hitch on the back of an automobile or truck. A trailer hitch is typically a square tube, welded to the frame of the vehicle under the rear bumper, with an open end for receiving a matting coupling on a trailer, the square tube has a series of holes on opposite sides which allow a locking pin to be inserted transversely to the hitch.

Hitch racks are bicycle carriers adapted to mount to a trailer hitch receiver by means of a coupling shaft or tube which slides into the open end of the trailer hitch receiver and slight movements of the coupling result in a significant and noticeable vibration at the upper end of the carrier frame which supports the bicycles. As a result, the bicycles are subjected to an unnecessary and potentially damaging movement.

What is needed is a more effective trailer hitch mounting for bicycle hitch racks which can substantially eliminate vibration and shaking of the rack on the transport vehicle during normal road travel. This improved mounting must be dependable, easy to use and of relatively simple construction.

### BRIEF DESCRIPTION OF THE DRAWINGS

FIG. 1 is a right side perspective view of the bicycle rack. The rack is in the upright position, the mast is perpendicular to the hitch. The carrier frame is in a closed position, parallel to the mast. The removable pins are securing the rack in this upright position. The carrier/mast pin is inserted through the carrier and the mast. The mast/hitch pin is inserted through the mast and the hitch.

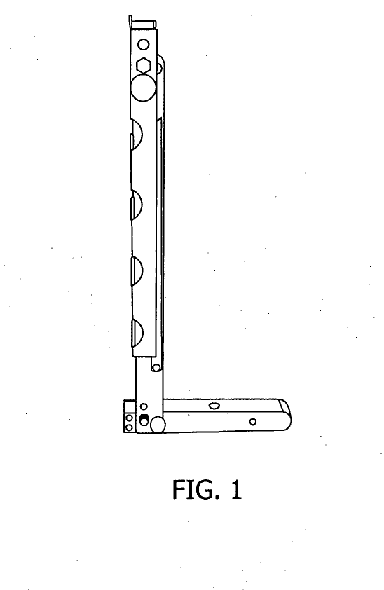

FIG. 2 is a right side perspective view of the bicycle rack in the open position.

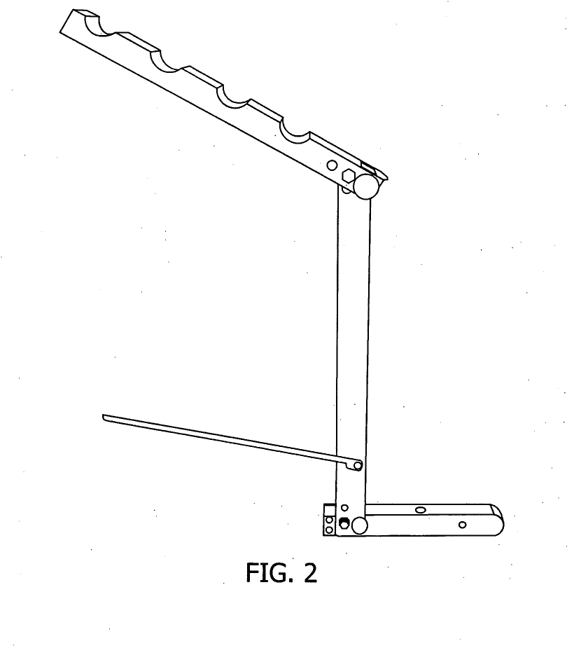

FIG. 3 is a right side perspective view of the bicycle rack with the carrier in a closed position and the mast downward 50° away from its upright position and the vehicle. The mast/hitch pin is inserted through the mast to prevent the mast from going further away from the vehicle

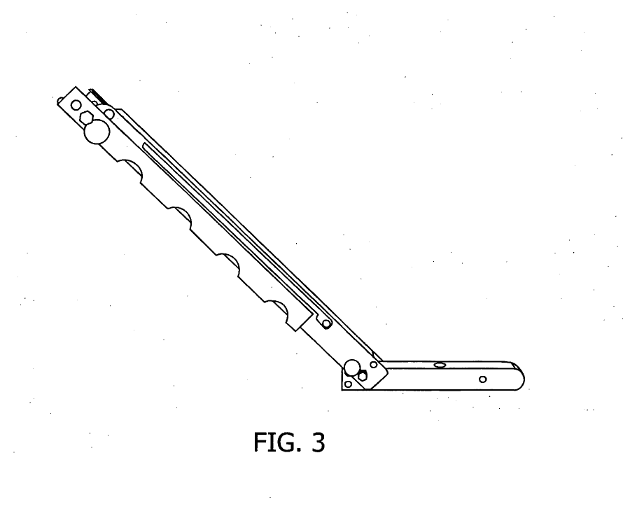

FIG. 4 is a right side perspective view of the bicycle rack with the carrier in a closed position and the mast downward 90° away from the upright position and the vehicle. In this position the mast is parallel to the hitch, completely horizontal.

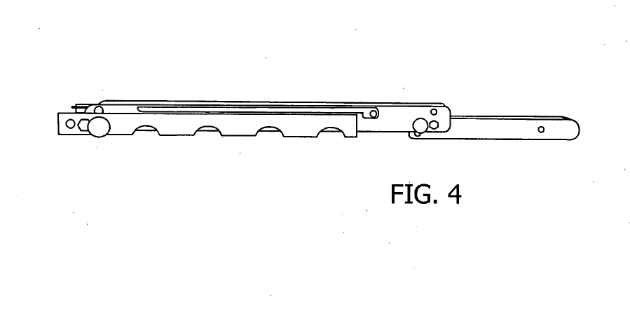

FIG. 5 is a front perspective view of the bicycle rack. The rack is in the upright position; the mast is perpendicular to the hitch. The carrier frame is in a closed position, parallel to the mast. The removable pins are securing the rack in this upright position. The carrier/mast pin is inserted through the carrier and the mast. The mast/hitch pin is inserted through the mast and the hitch.

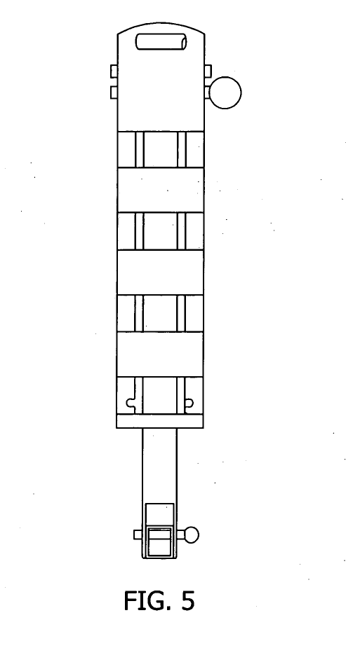

FIG. 6 is a rear perspective view of the bicycle rack. The rack is in the upright position; the mast is perpendicular to the hitch. The carrier frame is in a closed position, parallel to the mast. The removable pins are securing the rack in this upright position. The carrier/mast pin is inserted through the carrier and the mast. The mast/hitch pin is inserted through the mast and the hitch. The slots represented by #42 are use to place the rubber straps. The “w” cuts represented by #43 are used to tight the rubber straps when securing the bicycle to the carrier.

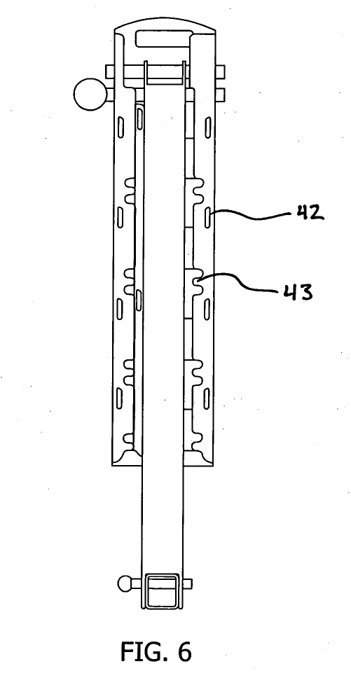

FIG. 7 is a right angular perspective view of the ergonometric design hitch described here as the invention. The ergonometric part of the hitch expands once inside the hitch receiver forcing the hitch receiver to contract at the same time, resulting in an almost full elimination of free play in a tight and secure retention of the bicycle rack.

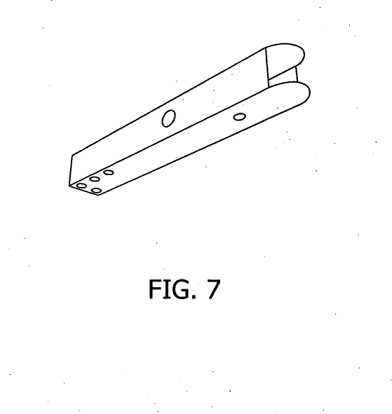

FIG. 8 is an exploded perspective view of the bicycle rack depicting the parts and their allocation.

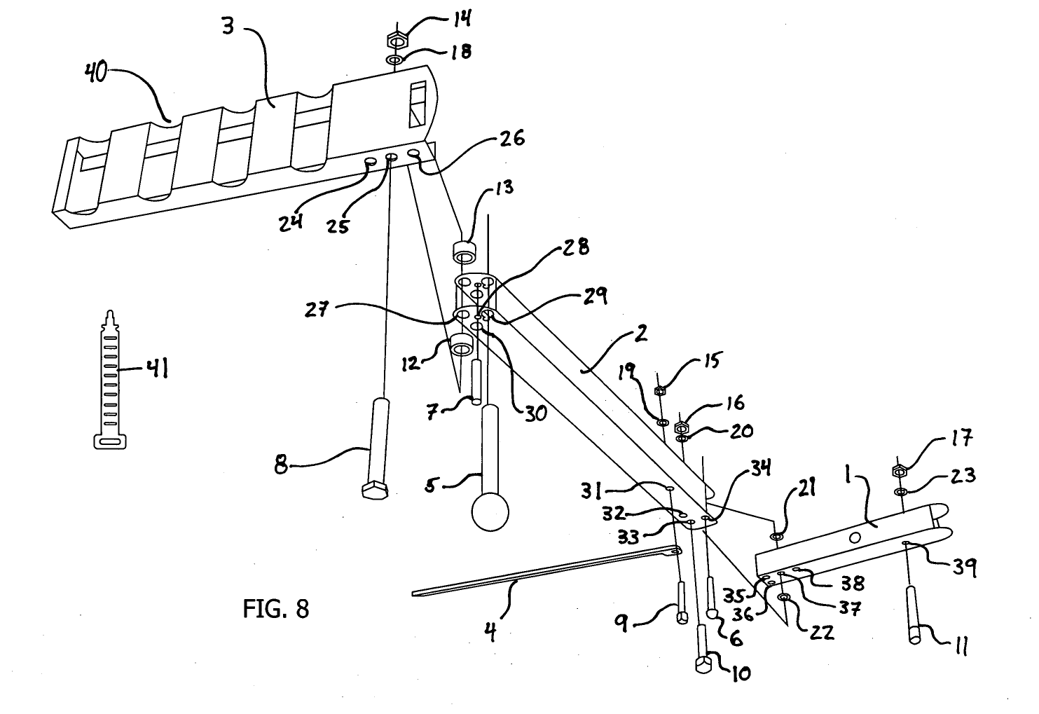

### SUMMARY OF THE INVENTION

This invention addresses the shortcomings of the prior art by providing improved trailer hitch mountings which hold the bicycle rack against vibrating on the trailer hitch receiver. According to this invention, a bike rack has a carrier for supporting one or more bicycles, a central upright frame named mast, with a lower end structure named hitch, for detachably securing the bicycle rack to a conventional hitch receiver, which is attached to the motor vehicle with a bolt, adjustable for effecting relative displacement of the two members transversely to the hitch making a tight friction-fit of the coupling to keep the bicycle rack from vibrating in the hitch receiver. The invention's main objective is to secure and stabilize the bicycles on the carrier, which is obtain by the ergonometric designed hitch fixed to the mast and slid able into the open end of a trailer hitch receiver. The especially designed ergonometric hitch is ensured by a bolt inserted through the aligned hole of the hitch to the hole in the vehicle's receiver. In effect, the ergonometric part of the hitch expands once inside the hitch receiver forcing the hitch receiver to contract at the same time, resulting in an almost full elimination of free play in a tight and secure retention of the bicycle rack.

A series of holes in the side walls admit a transverse locking cable for locking the hitch against withdrawal from the hitch receiver.

These and other features and advantages of the present invention will be better understood by reference to the following detailed description of the preferred embodiments taken together with the attached drawings.

1. A bicycle rack comprising:
a lower base metal frame that is mountable on a 2″ squared or 1¼″ squared hitch receiver of a vehicle.
a vertical metal mast that is assembled onto the lower base metal frame that is in turn assembled on the upper end to a rectangular frame specially designed to carry bicycles.
an upper rectangular metal frame designed to hold bicycles that is assembled on the upper end of the vertical mast previously described.

2. The lower base metal frame in claim 1 has rounded cut ends to be easily inserted in the hitch receiver of the vehicle with an ergonometric design. The ergonometric part of the hitch expands once inside the hitch receiver forcing the hitch receiver to contract at the same time, resulting in an almost full elimination of free play in a tight and secure retention of the bicycle rack.

3. The lower base metal frame in claim 1 has a narrower transverse securing hole that the hitch receiver so that the bolt head can fit inside the hitch receiver and tighten the lower base metal frame fast to the inner opposite wall of the hitch receiver.

4. The assembly of the vertical mast and the lower base frame in claim 1 is held by a bolt and is kept from rotating by a pin.

5. The pin in the juncture of the vertical mast and the lower base frame in claim 4 can be withdrawn and placed in three different holes allowing the joint of these two pieces to assume three different positions: upright, 50° down and away from upright, and completely horizontal.

6. The assembly of the upper rectangular frame and the vertical mast in claim 1 is held by a bolt and is kept from rotating by a pin.

7. The pin in the juncture of the upper rectangular frame and the vertical mast in claim 6 can be withdrawn and placed in two different holes allowing the joint of these two pieces to assume two different positions: vertically closed parallel to the vertical mast or extended 120° upward and away from the vertical mast and the vehicle.

8. The upper tubular frame has between one and four indentations in order to place and carry the bicycles.

9. Rubber neoprene straps are additionally used to secure and tight the bicycles to the indentations described in claim 8.

10. The anti-sway bar assembled onto the vertical mast rotates from a parallel position, in regards to the vertical mast, to a perpendicular position outwardly and holds the pedals in a fixed position using rubber straps preventing the bicycle from swaying.

11. A safety pin is placed in the juncture of the upper tubular frame and the vertical mast in order to detain the upper tubular frame should said member be dropped without a pin.
